(19) United States
(12) Patent Application Publication
(10) Pub. No.: US 2008/0083026 A1
(43) Pub. Date: Apr. 3, 2008

(54) Kerberos Protocol Security Provider for a Java Based Application Server

(75) Inventor: Timothy D. Sent, Dana Point, CA (US)

Correspondence Address: FLIESLER MEYER LLP, 650 CALIFORNIA STREET, 14TH FLOOR, SAN FRANCISCO, CA, 94108, US

(73) Assignee: BEA SYSTEMS, INC., San Jose, CA (US)

(21) Appl. No.: 11/560,274

(22) Filed: Nov. 15, 2006

Related U.S. Application Data
(60) Provisional application No. 60/848,853, filed on Oct. 2, 2006.

(51) Int. Cl. H04L 9/32

(52) U.S. Cl. 726/10

(57) ABSTRACT

A security provider is presented that integrates a Java based application server with Kerberos security protocol. The security provider includes a login module, a JMX MBean, an MBean definition file and a security provider java class. The JMX MBeans can contain various options that contain configuration information for the login module. The login module is responsible for authenticating the users by obtaining the user name and password, creating encryption keys, sending requests to the Kerberos key distribution center and receiving a ticket granting ticket encrypted with the user's password. The login module can then create an authenticated principal and add it to the subject associated with the user. The ticket granting ticket can also be added to the subject's private credentials. The security provider also supports the persistence of Kerberos credentials into a file based credentials cache.

The present application claims the benefit of U.S. Provisional Patent Application No. 60/848,853, entitled KERBEROS PROTOCOL SECURITY PROVIDER FOR A JAVA BASED APPLICATION SERVER, by Timothy D. Sent, filed on Oct. 2, 2006 (Attorney Docket No. BEAS-02077US0), which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates generally to providing security for application servers and web servers.

### BACKGROUND OF THE INVENTION

Deploying, maintaining and managing enterprise security has become a vastly important issue to organizations. To provide various services, an IT organization must typically address the fundamental matters of maintaining confidentiality, integrity and availability of the system and of its data. Various challenges to the security within organizations concern every component of the system, from individual machines to the overall network.

Java based application and web servers often implement modular forms of security for authenticating and authorizing users to access various services on the network. Authentication verifies the user's identity, such as via user ids and passwords and authorization typically permits the authenticated user to perform some operation. For example, a human resources application may permit a manager to access all employee information, while other employees may only be permitted to access their own information. Various authentication and authorization techniques are available in the art.

For example, MIT Kerberos is a computer network authentication protocol that provides security for entities or individuals that communicate over a computer network. Kerberos can protect against various known and unknown security attacks such as eavesdropping attacks, replay attacks, as well as provide integrity of data being sent across the network. This protocol makes use of a third party that is trusted by the entities that wish to communicate with one another. This third party may be called a Key Distribution Center (KDC) and it provides various ticket granting tickets (TGT) and service tickets that individuals can use to prove their identity and to secure the communications.

However, clients who use MIT Kerberos as their primary security infrastructure typically need to implement a parallel security infrastructure, such LDAP, in order to support authentication on various Java application servers and web servers. For example, applications that are Kerberized (support Kerberos authentication) are unable to participate in the security context of an application server authenticated user. This can prevent such a user from seamlessly integrating within the organization and from accessing all its services. Various enterprises have resolved these issues by adopting other security mechanisms such as the Lightweight Directory Protocol (LDAP) to integrate their Java servers such as WebLogic into their environments. However, this often resulted in duplication of efforts by the client to maintain separate and distinct security infrastructures, leading to duplication of maintenance, out-of-synch passwords and increased support calls for users who have forgotten their passwords. What is needed is a system that allows clients to maintain a single security infrastructure in which enterprises implementing the various distinct security protocols can participate.

### BRIEF DESCRIPTION OF THE DRAWINGS

FIG. 1 is an illustration of the Kerberos security provider within the context of enterprise security, in accordance with various embodiments of the invention.

FIG. 2 is an illustration of the various components that comprise the Kerberos security provider, in accordance with various embodiments of the invention.

FIG. 3 is an exemplary flowchart illustration of a high level view of the security provider functionality, in accordance with various embodiments.

FIG. 4 is an exemplary flowchart illustration of the login method invocation functionality of the security provider, in accordance with various embodiments.

FIG. 5 is an exemplary flowchart illustration of the authentication method invocation functionality of the security provider, in accordance with various embodiments.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device/appliance such as a router. Furthermore, it can also be apparent to those skilled in the art that such components, regardless of how they are combined or divided, can execute on the same computing device or can be distributed among different computing devices connected by one or more networks or other suitable communication means.

In accordance with various embodiments of the invention a Kerberos security provider is presented for extending a J2EE compliant application/web server with the ability to authenticate users against a Kerberos Distribution Center (KDC) using the Kerberos security protocol. The security provider includes four distinct parts. These are the security provider Java class file, the Kerberos JAAS login module Java class file, an extensible markup language (XML) based MBean Definition File and the various MBean Java class files. These components of the Kerberos security provider allow for seamless configuration, integration and management and administration of the security within the application or web server environment.

In one embodiment, the security provider Java class file component acts as the glue to bind the MIT Kerberos JAAS login module into the Java based application server security framework. It contains logic to pass configuration information provided from the JMX MBeans to the login module. This can be done by returning an instance of the AppConfigurationEntry Java class containing the login module class name, JAAS control flag (REQUIRED, OPTIONAL, REQUISITE, and SUFFICIENT) and a Map containing the login module's options extracted from the MBeans.

The login module component can be responsible for authentication and can implement the JAAS login module interface thereby adhering to the JAAS login module APIs. It can supply various lifecycle methods for processing authentication requests, such as initialization( ), login( ), commits, abort( ) and logout( ).

The XML-based MBean definition file (MDF) is the third component that comprises the Kerberos security provider. The MDF file defines the MBean type and attributes of the Kerberos security provider MBean. These can be programmatically manipulated using a variety of tools. The MDF describes various options contained in the MBeans, their data types and their valid range of values.

The JMX MBean is the component that is generated by the MDF file described above. It stores the options used by the Kerberos security provider which can be specified via a management console or configured using various scripting tools.

The Kerberos security provider can implement the above described components in order to use the Java Authentication and Authorization Service (JAAS) to request user name and password values from the user via JAAS callbacks. It can then use those values to make a request to the Kerberos Key Distribution Center (KDC) for a ticket granting ticket (TGT). The KDC can return this TGT, encrypted with the user's password, to the security provider. The Kerberos security provider can then create a JAAS principal and store this principal, along with the Kerberos credentials into a JAAS subject associated with the user. Optionally, the security provider can also support persistence of the credentials into a file-based credentials cache.

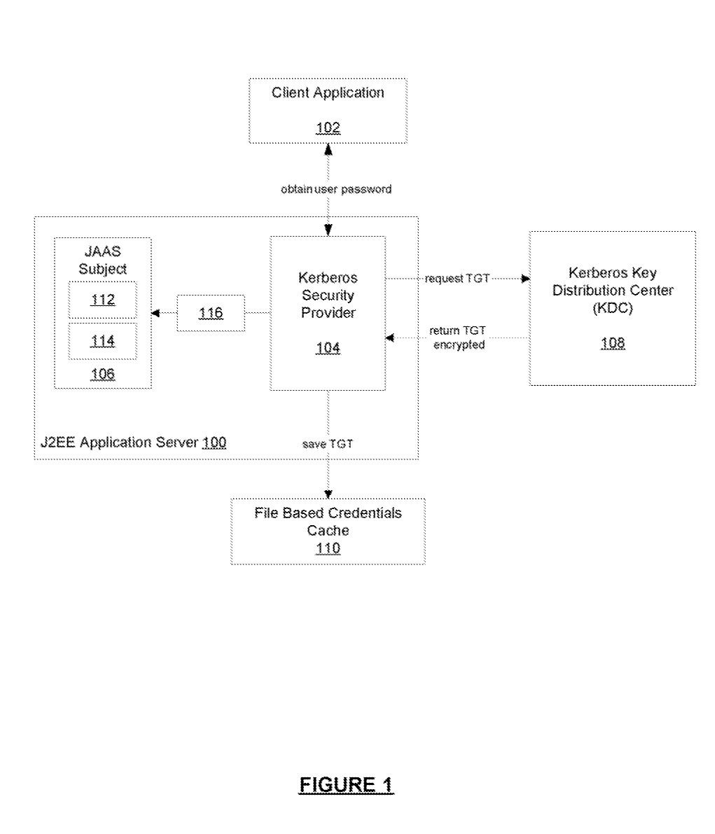

FIG. 1 is an illustration of the Kerberos security provider within the context of enterprise security, in accordance with various embodiments of the invention. Although this diagram may depict components as logically separate, such depiction is merely for illustrative purposes. It will be apparent to those skilled in the art that the components portrayed in this or other figures can be combined or divided into separate software, firmware and/or hardware components. Furthermore, it will also be apparent to those skilled in the art that such components, regardless of how they are combined or divided, can execute on the same computing device or can be distributed among different computing devices connected by one or more networks or other suitable communication means.

As illustrated, the Kerberos security provider 104 can extend a J2EE compliant web or application server 100, such as WebLogic server to accept Kerberos credentials for authentication. The security provider can use Java Authentication and Authorization Service (JAAS) to obtain user name and password values from the user or client application 102 via JAAS callbacks. The security provider then makes requests to the Kerberos Key Distribution Center (KDC) 108 for a ticket granting ticket (TGT) and obtains such a TGT. In one embodiment the TGT is a data structure encoded with the user's password that gives that user privileges for accessing various services within the organization. This TGT can later be used to obtain service tickets to access the various entities and services on the network.

If authentication is successful, the security provider can store the credentials (TGT) into a JAAS subject along with a JAAS principal 116. This JAAS subject 106 is a collection of security information for the user and the subject stays with that user for the life of the session. For example, the subject can contain principals as well as private credentials such as the TGT and service tickets. The security provider also supports the persistence of the Kerberos credentials into a file-based credentials cache 110. This file based credentials cache can enable the user to authenticate itself without actually propagating the service ticket to the various network services. In cases when such electronic propagation of the ticket is not desirable, a user can simply propagate its principal and the name of its credentials cache to the service and the service can authenticate against that cache file.

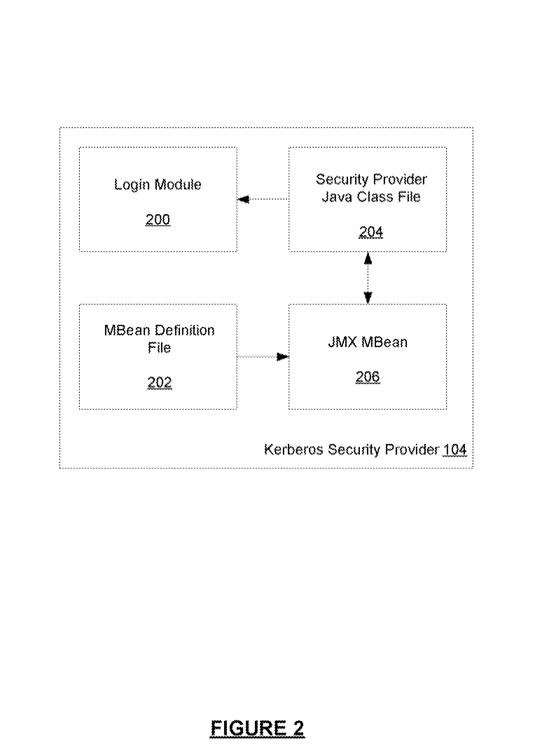

FIG. 2 is an illustration of the various components that comprise the Kerberos security provider, in accordance with various embodiments of the invention. Although this diagram may depict components as logically separate, such depiction is merely for illustrative purposes. It will be apparent to those skilled in the art that the components portrayed in this or other figures can be combined or divided into separate software, firmware and/or hardware components. Furthermore, it will also be apparent to those skilled in the art that such components, regardless of how they are combined or divided, can execute on the same computing device or can be distributed among different computing devices connected by one or more networks or other suitable communication means.

As illustrated, the security provider 104 can consist of four distinct parts which enable the functionality that will be described in further detail below. These four components include the security provider Java class file 204, the login module Java class file 200, an XML based MDF (MBean definition file) 202 and the MBean Java class files 206.

The Kerberos security provider Java class 204 binds the login module into the J2EE server security framework. It can implement the security provider interface and can adhere to the security provider framework API's. Furthermore, the security provider contains the logic to pass configuration information provided from the JMX MBeans 206 to the login module 200. This can be performed by returning an instance of the AppConfigurationEntry Java class containing the login module name, JAAS control flag (REQUIRED, OPTIONAL, REQUISITE and SUFFICIENT) and a Map containing the login module options extracted from the JMX MBean 206.

The login module 200 Java class is responsible for authentication. It can implement the JAAS login module interface and can adhere to the JAAS login module API's. The login module interface supplies various lifecycle methods for processing authentication requests, including initializationo, login( ), commits, abort( ), and logout( ).

The MBean Definition File (MDF) 202 can define the MBean type and attributes of the Kerberos security provider MBean 206. These are usually reflected in the server management console and can be programmatically manipulated using a variety of tools. The MDF describes each of the options used during login and authentication (these options will be described in further detail below) and their data types and valid range of values.

The final component of the Kerberos security provider can be the JMX MBean 206. This component can be generated by the XML based MDF file described above. The MBean can store the security provider options which can be specified using the web server management console or configured using various scripting tools as available in the art.

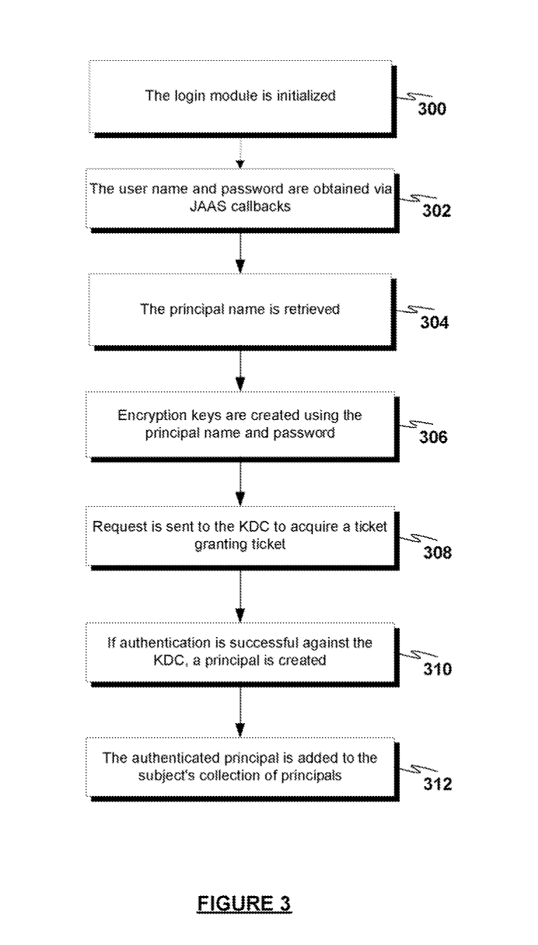

FIG. 3 is an exemplary flowchart illustration of a high level view of the security provider functionality, in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

As illustrated in step 300, the login module is initialized by invoking the appropriate initializationo method of the module. During this invocation, the login module captures the settings passed in from the security framework, as illustrated in step 302. These settings can include the JAAS subject, JAAS callback handler, a map containing shared state information that is passed between various configured login modules during authentication, and a map containing the options passed in from the above mentioned security provider Java class.

In step 304, the security provider can obtain the user name and password values from the user or client application. This can be done by reading the shared state map passed in to the login module during initialization. Alternatively, the provider can use the callback handler to retrieve the information from the user. In step 306, an encryption key is created which will later be used to communicate with the KDC. The encryption key can be created by utilizing the user name and password values obtained earlier in step 304. Various encryption techniques can be used as are well known in the art, and this disclosure is not limited to any specific encryption process. In step 308, a request is sent to the KDC for a ticket granting ticket. Such a request is typically made using the user (or principal) name and the encryption keys. As used herein, a principal represents a user or a group of users. In step 310, if the KDC returns a TGT, authentication can be considered successful against the Kerberos server and a user implementation class is created representing the principal. This authenticated principal is then added to the JAAS subject, as illustrated in step 312. Such a subject can typically have a collection of multiple principals that have been authenticated using various techniques.

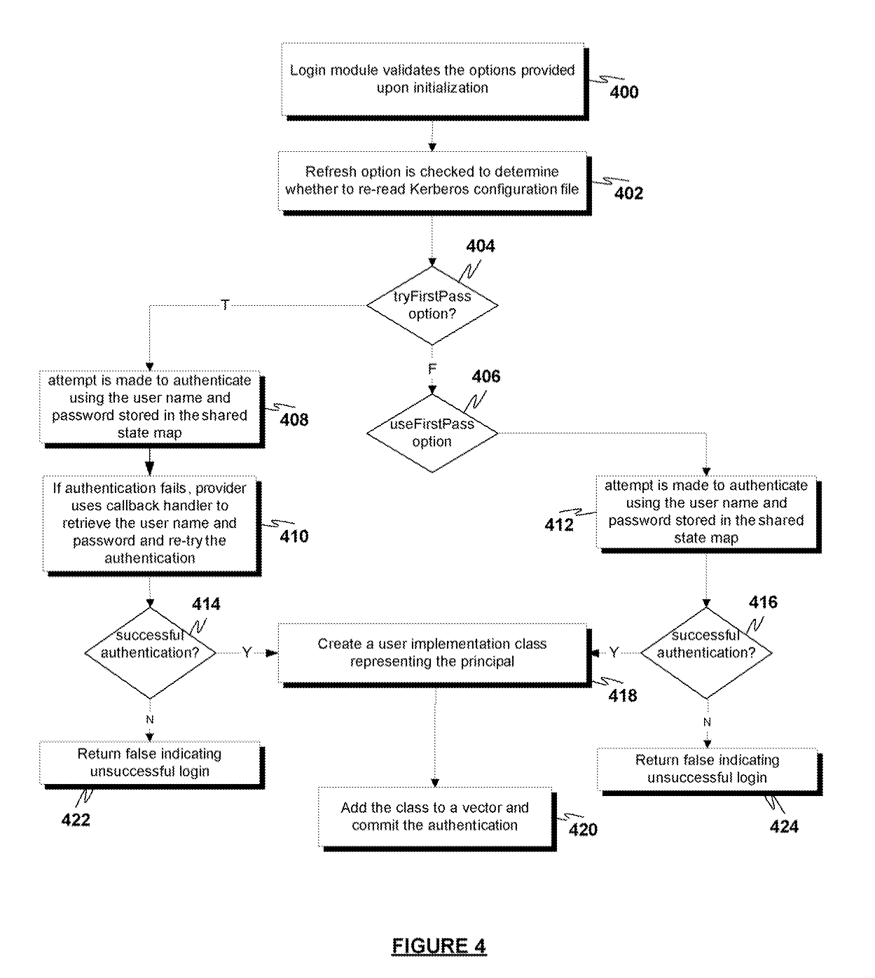

FIG. 4 is an exemplary flowchart illustration of the login method invocation functionality of the security provider, in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

During the invocation of the login( ) method, the login module first validates the options provided upon initialization, as illustrated in step 400. If these are found inconsistent or incomplete, a login exception can be thrown with information about the inconsistency or deficiency. In step 402, the refresh Kerberos configuration option is checked in order to determine whether a refresh of the configuration Java class should be forced. If the option evaluates to true, the login module can force the refresh resulting in a re-read of the krb5.conf Kerberos configuration file.

In step 404, the try first pass option is checked. If this option is set to true, an attempt can be first made to authenticate using the user name and password stored in the shared state map passed in during initialization, as illustrated in step 408. If this authentication attempt fails, the provider can use the call back handler to retrieve the user name and password and then attempt the authentication a second time, as illustrated in step 410. At this point if the second attempt is also unsuccessful in step 414, the login( ) method returns a false indicating to the security framework that login was unsuccessful, as illustrated in step 422.

In step 406, the use first pass option can be checked. If this option evaluates to be true, an attempt can be made to authenticate using the user name stored in the shared state map passed in during initialization. If authentication fails, the login( ) method can return a false indicating to the framework that login was unsuccessful, as illustrated in steps 412, 416 and 424. A choice of above options can be utilized by an enterprise, depending on the particular security or administrative requirements.

If the authentication process is successful, as illustrated in step 418, a user implementation class can be created representing a principal. This can then be added to a vector in preparation for the commits method, as illustrated in step 420. During the invocation of the commits method, the vector containing the authenticated principal can be added to the JAAS subject's principal collection. At this point the store key option can be checked in order to determine whether the Kerberos key should be added to the subject's private credentials. If the option evaluates to true, the key can be added, and the commits method can return a value of true to the security framework, indicating successful login and authentication.

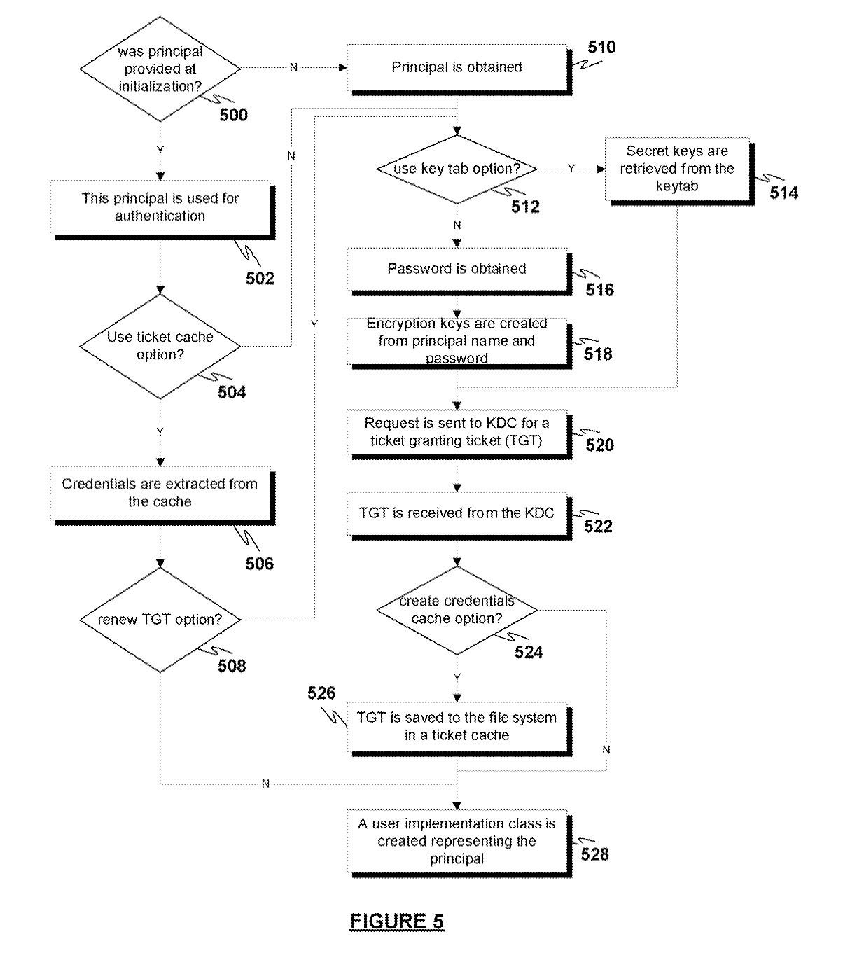

FIG. 5 is an exemplary flowchart illustration of the authentication method invocation functionality of the security provider, in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

During authentication, a check can be made to the krb5PrincName to determine whether a principal name was provided in the options during the initialization, as shown in step 500. If so, this is the principal used for authentication, as shown in step 502. In step 504, the use ticket option is then examined to determine if the ticket cache should be used to extract credentials for the specified principal. If this option evaluates to be true, the credentials are retrieved from the cache, as illustrated in step 506. If the renew TGT option is set to true, as determined in step 508, then an attempt to renew the credentials can be made. If the ticket has not passed its renew time this succeeds, otherwise an exception can be thrown and the credentials are no longer valid.

If the credentials have not been successfully retrieved and no principal name has yet been identified, an attempt to retrieve the principal name is made, as shown in step 510. The do not prompt option can be interrogated and if true, an exception can be thrown. If this option is false, a NameCallback can be created and passed to the CallbackHandler's handles method to request this information from the user.

Once the principal name has been retrieved, the use key tab option can be checked, as illustrated in step 512. If true, an attempt can be made to retrieve the secret keys from the keytab, as shown in step 514. If the use key tab option is false or the secret keys were not obtained, the user's password can be obtained, as illustrated by step 516. A password callback can be created and passed to the CallbackHandler's handles method in order to perform this function.

In step 518, with a valid principal name and the password, the encryption keys are created by the security provider. Using these encryption keys and the principal name, a request is made to the key distribution center (KDC) to acquire the TGT, as shown in step 520. In step 522, the TGT encrypted with the user password can be received from the KDC. At this point, the create credentials cache option can be checked, as shown in step 524. If this option is set to true, the TGT can be saved to the file system, such as to a file specified by the ticketCacheName, as shown in step 526. A credentials cache can contain various tickets such as the ticket granting ticket (TGT) or service tickets for accessing various services within the organization. This cache can be useful in situations when electronic propagation of various tickets is not desirable. In such cases, the service can be informed of the name of the cache file and the principal name in order to authenticate and the actual ticket need not be sent electronically.

In step 528, with successful authentication against the KDC, a user implementation class such as WLSUserImpl Java class can be created representing the principal. This is then added to the Vector in preparation for the commits method. During the commits method, the vector containing the authenticated principal can be added to the subject's principal collection, at which point the Kerberos key can also be added to the subject's private credentials collection, if the appropriate option is so configured.

An exemplary list of options which have been discussed throughout this specification is presented below for illustrative purposes. It will be apparent to one of ordinary skill in the art that the embodiments of the invention are not limited to these particular options and that other such options or techniques can be implemented and are well within the scope of the invention.

| Option Name | Brief Description |
|---|---|
| Debug | If this is true, sends debug statements to System.out. |
| doNotPrompt | If this is true, the user will not be prompted for a user name or |
| | password. |
| ticketCacheName | The fully qualified name of the Kerberos ticket cache file. This is used |
| | in conjunction with either the useTicketCache or createTicketCache |
| | options. |
| createTicketCache | If this is true, the Kerberos credentials will be stored in a cache file, |
| | specified by the ticketCacheName, on the file system. |
| useTicketCache | If this is true, the ticket cache, specified by the ticketCacheName, will |
| | be used to retrieve the principal's key. |
| keyTabName | The fully qualified name of the keytab file containing the principal's |
| | secret key. |
| princName | The name of the principal being authenticated. |
| refreshKrb5Config | If this is true, the Kerberos configuration from the krb5.conf file will |
| | be refreshed. |
| renewTGT | If this is true, the ticket granting ticket from the KDC will be renewed. |
| tryFirstPass | If this is true, an attempt will be made to authenticate using |
| | information provided in the shared state map passed in during |
| | initialization. The provider will extract the user name and password |
| | from the shared state map using the following keys |
| | “javax.security.auth.login.name” and |
| | “javax.security.auth.login.password”. It will then attempt |
| | authentication using these values. If authentication fails, the provider |
| | will use the CallbackHandler to retrieve the user name and password |
| | and then attempt authentication a second time. If the second attempt is |
| | also unsuccessful, the WebLogic security framework is notified of the |
| | failure. |
| useFirstPass | If this is true, an attempt will be made to authenticate using |
| | information provided in the shared state map passed in during |
| | initialization. The provider will extract the user name and password |
| | from the shared state map using the following keys |
| | “javax.security.auth.login.name” and |
| | “javax.security.auth.login.password”. It will then attempt |
| | authentication using these values. If authentication fails, the WebLogic |
| | security framework is notified of the failure. |
| storeKey | If this is true, the provider stores the Kerberos key into the JAAS |
| | subject's private credentials. |
| storePass | If this is true, the user name and password returned by the |
| | CallbackHandler are stored in the shared state map using the following |
| | keys “javax.security.auth.login.name” and |
| | “javax.security.auth.login.password”. This will occur if no values are |
| | already associated with the keys and authentication is successful. |
| clearPass | If this is true, the values stored in shared stat for the following keys |
| | “javax.security.auth.login.name” and |
| | “javax.security.auth.login.password” will be cleared. |

Various embodiments of the present invention may be implemented using a conventional general purpose of a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features present herein. The storage medium can include, but is not limited to, any type of disk including floppy disks, optical discs, DVD, CD-ROMs, micro drive, and magneto-optical disks, ROMs, Rams, EPROM's, EPRO'Ms, Drams, Rams, flash memory of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

Embodiments of the present invention can also include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer implemented method for transmitting code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code; or causing the code to pass into any region or country from another region or country. For example, transmitting includes causing the transfer of code through a portion of a network as a result of previously addressing and sending data including the code to a user. A transmission to a user can include any transmission received by the user in any region or country, regardless of the location from which the transmission is sent.

Embodiments of the present invention can include a signal containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments where chosen and described in order to best explain the principles of the invention and its practical application, thereby enabling others skilled in the art to understand the invention for various embodiments and with various modifications that are suited to the particular used contemplated. It is intended that the scope of the invention be defined by the claims and their equivalents.

What is claimed is:

1. A system for providing security in a Java server network environment, the system comprising:
a login module that authenticates at least one user, said login module adapted to receive a user name and a user password, generate an encryption key and request a ticket granting ticket (TGT) from a key distribution server;
a JMX MBean that contains one or more options for configuring security on the network;
an MBean definition file that defines type and attributes of the JMX MBean; and
a security provider component adapted to pass the one or more options from the JMX MBean to the login module.

2. The system of claim 1 wherein the login module is further adapted to receive the TGT from the key distribution center and create a principal.

3. The system of claim 2 wherein the login module is further adapted to store the principal into a JAAS subject associated with the user.

4. The system of claim 3 wherein the login module is further adapted to store the TGT into the JAAS subject's private credentials.

5. The system of claim 1 further comprising:
a file based ticket cache for storing the TGT after receiving it from the key distribution center.

6. The system of claim 1 further comprising:
a shared state map passed to the login module during initialization wherein the shared state map contains state information that is shared among the login module and one or more other login modules.

7. The system of claim 6 wherein the one or more options include a try first pass option that directs the login module to attempt to authenticate the user by using the user name and the user password contained in the shared state map and if authentication fails, to request the user name and the user password from the user.

8. The system of claim 1 wherein the one or more options include a create ticket cache option that directs the login module to store the TGT into a file based ticket cache.

9. The system of claim 1 wherein the one or more options include a use key tab option that directs the login module to retrieve a key for the user from a keytab file.

10. The system of claim 8 wherein the one or more options include a renew TGT option that directs the login module to refresh the TGT after reading it from the ticket cache, said refreshing performed by sending another request to the key distribution center.

11. A method for providing security in a Java server network environment, the method comprising:
receiving a user name and password;
generating an encryption key by using the user name and the password;
sending a request for a ticket granting ticket (TGT) to a key distribution center said request including the encryption key and the user name;
receiving the TGT from the key distribution center; and
creating an authenticated principal and storing the authenticated principal to into a subject.

12. The method of claim 11 wherein receiving user name and password further includes:
creating a name callback and passing the name callback to the handle method of the callback handler to request this information from the user.

13. The method of claim 11 further comprising:
storing the TGT into the subject as the subject's private credentials.

14. The method of claim 11 wherein further comprising:
storing the TGT into a file based credentials cache.

15. The method of claim 14 wherein the TGT can subsequently be read from the credentials cache without re-sending the request to the key distribution center.

16. The method of claim 11 wherein the TGT is encrypted with the password.

17. The method of claim 11 further comprising:
attempting to retrieve a secret key from a keytab after receiving the user name.

18. The method of claim 11 further comprising:
providing one or more JMX MBeans for storing options that controlling security.

19. The method of claim 11 further comprising:
requesting to use a service on a network by a client wherein the client sends the TGT to the key distribution center and obtains a service ticket for accessing said service.

20. A computer readable medium having a set of instructions stored thereon, which when executed by one or more processors cause a system to:
receive a user name and password;
generate an encryption key by using the user name and the password;
send a request for a ticket granting ticket (TGT) to a key distribution center said request including the encryption key and the user name;
receive the TGT from the key distribution center; and
create an authenticated principal and store the authenticated principal into a subject.
